(19) United States
(12) Patent Application Publication
(10) Pub. No.: US 2003/0041963 A1
(43) Pub. Date: Mar. 6, 2003

(54) Reactivatable adhesives

(76) Inventors: Lie-zhong Gong, Bridgewater, NJ (US); Renu Lamba, Morganville, NJ (US); David J. Good, Somerville, NJ (US); Justin A. Mehaffy, Flemington, NJ (US)

Correspondence Address: Cynthia L. Foulke, National Starch and Chemical Company, 10 Finderne Avenue, Brigdewater, NJ, 08807, US

(21) Appl. No.: 09/933,279

(22) Filed: Aug. 20, 2001

(51) Int. Cl. B32B 31/00

(52) U.S. Cl. 156/272.2; 156/308.2

(57) ABSTRACT

A reactivatable adhesive that may be used on high speed case and carton sealing lines contains an energy absorbing ingredient that is capable of absorbing and reflecting radiant energy.

### FIELD OF THE INVENTION

The invention relates to adhesives. More specifically, the invention is directed to reactivatable adhesives and uses thereof.

### BACKGROUND OF THE INVENTION

Adhesives are widely used for various commercial applications. Hot melt adhesives, for example, are commonly used in product assembly and packaging applications, including cardboard case sealing and carton closing operations. Such hot melt adhesives are applied to a substrate while in its molten state and cooled to harden the adhesive layer.

In the conventional case and carton packaging process for food and consumer applications, the boxes are first filled with food or consumer goods, then a hot melt adhesive is applied to the flap of boxes on the packaging line and compression is exerted to seal the boxes. While this process works reasonably well, it requires the packaging company to devote a tremendous amount of time and attention to adhesive-related issues, including adhesive selection, processing, trouble shooting and inventory. First, selection of an adhesive having the required adhesion, setting speed, and open time is a lengthy process. Then the adhesive needs to be processed in an appropriate way such as melting, transporting, and applying. If anything is wrong with the processing, the boxes will not seal properly, the packaging line must be stopped, and the problem identified and fixed.

Re-activation or heat sealing of pre-applied adhesives is known and practiced in the art. Heat sealed closures and seams are commonly used in the manufacture of bags, whereby adhesive is coated on the inside of the bag seam and subsequently sandwiched under intense heat and pressure using heated platens or bars. This direct application of heat and pressure renders the adhesive molten, after which a bond is formed. This application benefits from the ability to apply steady direct pressure to ensure intimate contact and sufficient wetting. This process cannot be used for applications where high pressure for closing is not available, such as in case and carton packaging processes. While focused hot air has been used in the reactivation of pre-applied adhesives used in case and carton sealing operations, this method requires extremely large amounts of energy and can result in undesired heating of the substrate or package, its contents, and the surrounding area and equipment.

A need exists in the art for an adhesive that can advantageously be used for case and carton sealing whereby the adhesive may be pre-applied to a case or carton and later, following packaging, re-activated to close or seal the case or carton. The current invention addresses this need.

### SUMMARY OF THE INVENTION

The invention provides a means and adhesive or sealant composition that may be preapplied to a substrate and, when ready to use, reactived upon exposure to short durations of radiant energy. The reactivatable adhesives of the invention may advantageously be used in case and carton sealing applications.

One aspect of the invention is directed to a reactivatable adhesive composition comprising an effective amount of an energy-absorbing ingredient such that upon exposure of the adhesive to radiant energy, the adhesive is activated. A preferred embodiment of the adhesive is a hot melt adhesive formulation.

Radiant energy which may be used to reactive the adhesives of the invention will desirably have a wavelength of from about 400 nm to about 100,000 nm.

The energy-absorbing ingredient selected for use may be dissolved and/or dispersed within the adhesive composition. Organic dyes and pigments are particularly useful energy-absorbing ingredients for use in the practice of the invention.

Another aspect of the invention is directed to a reactivatable adhesive containing an energy-absorbing ingredient that has been applied to at least a portion of a first substrate and allowed to solidify. Upon subsequent exposure to radiant energy, the adhesives melts to the extent that it is capable of bonding the first substrate to a second substrate.

Yet another aspect of the invention is directed to a process for bonding at least a first substrate to at least a second substrate, wherein at least a portion of at least one of said substrates has applied thereon a reactivatable adhesive comprising an energy-absorbing ingredient. The method comprises irradiating the applied adhesive with radiant energy for a time sufficient to melt the adhesive, bringing one of said substrates in contact with the melted adhesive on the other substrate, and allowing the adhesive to solidify thereby bonding the first substrate to the second substrate.

Still another aspect of the invention is directed to articles of manufacture comprising a reactivatable adhesive comprising an energy-absorbing ingredient. Articles encompassed by the invention include, but are not limited to, containers such as cases, cartons, boxes, trays and bags, and nonwoven absorbent articles such as diapers and the like.

Another aspect of the invention is directed to a method of closing a container having applied on at least one surface substrate thereof the reactivatable adhesive comprising an energy absorbing ingredient. The method comprises exposing the reactivatable adhesive to radiant energy for a time sufficient to melt said adhesive, bringing a second surface substrate in contact with the reactivated adhesive on the first surface substrate and, optionally, applying pressure to effect said closing. In the practice of the invention, exposure to radiant energy is typically for periods of less that about 5 seconds. Pressure is typically applied for periods of less than about 30 seconds.

### DETAILED DESCRIPTION OF THE INVENTION

Conventional hot melt adhesives used in the packaging and converting markets require large amounts of energy to melt, especially when the means of melting is by irradiation with near infra-red (NIR), infra-red (IR), and/or visible light. Since conventional adhesives are largely transparent to NIR radiation, excessive transmission of light to the adhesive/substrate interface occurs, thereby heating the substrate. This low absorption by hot melt adhesives significantly reduces the reactivation efficiency of hot melt adhesives and, therefore, typically cannot be used for high speed packaging applications. This preferential heating of the substrate greatly extends the time for bond development (set speed) making reactivation impractical.

It has now been discovered that the absorption, reflection and transmission characteristics of a thermoplastic can be tailored, particularly those used as adhesives, so as to optimize the materials re-activation and subsequent bond formation. The current invention provides a composition and means by which an applied adhesive can be melted, or heated in a more efficient manner.

Hot melt adhesives are 100% solid materials which do not contain or require any solvent and are solid at room temperature. On application of heat, a hot melt adhesive melts to a liquid or fluid state in which form it is applied to a substrate. On cooling, the hot melt adhesive regains its solid form, thereby gaining its cohesive strength. Hot melt adhesives can be heated to a liquid state and cooled to a solid state repeatedly.

Reactivation, as this term is used herein, refers to an adhesive that resides on at least a portion of at least one substrate to be bonded. That is, the adhesive has been applied to a substrate in the molten state and allowed to cool, i.e., solidify, thereon. The adhesive present on the substrate is thereafter reactivated or heated to a molten state, brought in contact with a second substrate and allowed to cool or solidify, thereby bonding the two substrate together. The application of the adhesive onto a substrate for later activation or “reactivation” is referred to herein, and in the art as a “pre-applied” adhesive. The adhesive present on the substrate may be reactivated anytime after initial application to the substrate for bonding to a second substrate.

The adhesive composition of the invention has increased absorption and reduced transmission of electromagnetic energy that creates a temperature distribution within the adhesive that optimizes performance. The adhesives have improved re-activation and performance properties after irradiation. The adhesives of the invention reactivate on exposure to short durations of radiant energy and provide superior on-line performance and set speed which allows for quicker production speeds.

The improved re-activation and performance is achieved by incorporating into an adhesive an energy-absorbing ingredient. Energy-absorbing ingredients include those dyes, pigments, fillers, or other ingredients that are capable of absorbing energy and provide an optimal balance of absorption, reflection, transmission and conduction.

It has been discovered that when a suitable energy-absorbing ingredient is added to a conventional hot melt adhesive, reactivation upon short duration of radiant energy can be achieved. Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxynaphthylazo)azo-benzene), Solvent Green, and Cyanine-based dyes, oxides such as such as titanium dioxide, and metals such as antimony.

Dyes, such as Forest Green and Royal Blue masterbatch dye available from Clariant, will preferably have an absorption in the range of from about 400 nm to about 100,000 nM. Pigments, such as carbon black and graphite, are particulate in nature and will usually will have somewhat of a spherical shape with average particle sizes in the range of about 0.01 to about 7 microns. Pigment particles aggregate, so aggregate size will be larger. The pigment aggregate size in hot melt adhesives should be smaller than 500 microns, preferred aggregate size should be less than 100 microns, more preferably smaller than 50 microns.

Preferred energy-absorbing ingredients for use in the practice of the invention are broad band IR absorbers such as Epolight 1125 (Epolene, Inc), SDA6248 (H. W. Sands Corp.), SDA2072 (H. W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Suitable energy-absorbing ingredients for use in reactivatable adhesives of the invention may be identified by blending any desired conventional hot melt adhesive with a chosen additive of various particle size and various amounts. Any conventional method of blending the energy-absorbing ingredient with the adhesive such as through use of a paddle mixer or high shear mixer such as Ross ME-100LC, as would be apparent to the skilled practitioner, may be used to prepare the adhesive compositions of the invention. The starting adhesive and the adhesive containing the energy-absorbing ingredient then are compared by heating samples of each with a light from a radiant heat source. The samples are tested for reactivation efficiency and bonding performance, as described in detailed in the Examples. Reactivation efficiency is the ability the adhesive to become molten in a short period of time. Suitable additives are those that reactivate quickly and exhibit acceptable bond strength. Preferred are thermoplastic adhesives which, when pre-applied to a substrate, re-activates with a short duration of exposure to radiant energy, preferably less that about 10 seconds, more preferably less than about 5 seconds, and provides acceptable bond force after a short period of compression or cooling, preferably a period of less that about 30 seconds, more preferably less than about 15 seconds.

Radiant energy can be supplied by a number of sources, as will be apparent to the skilled practioner. Examples include lasers, a high pressure xenon arc lamp, a coiled tungsten wire, ceramic radiant heater and tungsten-halogen lamps. Preferred for use is radiant energy within the near infra-red (NIR) region. Wavelengths of from 400 nm to about 100,000 nm are contemplated for use. More typically, wavelengths of from 750 nm to about 10,000 nm, most typically from about 750 nm to about 5000 nm will be used in the practice of the invention. Commercial sources of equipment capably of generating radiant heat required for use in the practice of the invention include Research Inc. (Eden Prairie, Minn.), Chromalox (Ogden, Utah), DRI (Clearwater, Fla.), Advent Electric Inc. (Bridgeport, Pa.), and Glo-Quartz Inc. (Mentor, Ohio).

While traditional adhesives are primarily transparent to NIR, the adhesives of the invention absorb and reflect the energy. This allows for quicker reactivation, while hindering the energy from impinging on the substrate surface thereby creating a weak thermal boundary layer and extending the set time.

The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation slot-coating, swirl spraying, excrusion, atomized spraying, gravure (pattern wheel transfer) and screen printing. The method of pre-application to the substrate is not critical to the practice of the invention.

The reactivation efficiency, i.e., the ability of the adhesive to become molten in a short period of time will depend on the power of the device and the distance of the light source from the adhesive. Reactivation time depends on receptivity of the adhesive, which depends on the coating weight or thickness of the adhesive and the light flux density that the radiant source can supply to the adhesive (e.g., intensity per unit area). Light flux density refers to the distance, focal point, power and intensity of the lamp or power source.

The type of adhesive that can be reactivated in accordance with the invention is not particularly limiting or critical to the practice of the invention. Thermoplastic and hot melt adhesives are particularly useful when formulated for pre-application and subsequent later reactivation.

Any conventional polymers suitable for use in formulating adhesives, as are well known to those skilled in the art, may be used in the practice of the invention. Typically, adhesive formulations to which the additive of the invention may be added comprise a wax or diluent, a thermoplastic polymer and a tackifer. In all cases, the adhesive may be formulated with tackifying resins, plasticizers, waxes and/or other conventional additives such as antioxidants and stabilizers in varying amounts as are known to those skilled in the art and as required for particular formulations.

Hot melt adhesives may be prepared using techniques known in the art. Typically, the adhesive compositions are prepared by blending the components in the melt at a temperature of about 100° to 200° C. until a homogeneous blend is obtained, usually about two hours. Various methods of blending are known and any method that produces a homogeneous blend is satisfactory.

The energy-absorbing ingredient may be added, with stirring, any time during the preparation of the base adhesive, or following preparation of the base adhesive. The amount added will depend on the type of additive the size and the dissolution or dispersion properties. The additive is added in an amount effective to reactivate (melt) the adhesive upon exposure to short durations (typically less that 10 seconds) of radiant energy. Typically, the additive will be present in an amount of about 0.001 to about 10 parts per 100 parts of the adhesive composition.

The adhesive is applied to a substrate while in its molten state and cooled to harden the adhesive layer. The adhesive product can be applied to a substrate such as a cardboard substate, nonwoven article, etc, by a variety of methods including coating or spraying in an amount sufficient to cause the article to adhere to another substrate upon reactivation.

The adhesives of the invention find use in packaging, converting, bookbinding, bag ending and in the nonwovens markets. The adhesives find particular use as case, carton, and tray forming, and as sealing adhesives, including heat sealing applications, for example in the packaging of cereals, cracker and beer products. Encompassed by the invention are containers, e.g., cartons, cases, boxes, bags, trays and the like, wherein the adhesive is applied by the manufacturer thereof prior to shipment to the packager. Following packaging, the container is heat sealed by reactivatiing the preapplied adhesive using radiant energy.

The substrates to be bonded include virgin and recycled kraft, high and low density kraft, chipboard and various types of treated and coated kraft and chipboard. Composite materials are also used for packaging applications such as for the packaging of alcoholic beverages. These composite materials may include chipboard laminated to an aluminum foil which is further laminated to film materials such as polyethylene, mylar, polypropylene, polyvinylidene chloride, ethylene vinyl acetate and various other types of films. Additionally, these film materials also may be bonded directly to chipboard or kraft. The aforementioned substrates by no means represent an exhaustive list, as a tremendous variety of substrates, especially composite materials, find utility in the packaging industry.

The invention is further illustrated by the following non-limiting examples.

### EXAMPLES

All the formulations were subjected to the following two tests to determine the reactivation efficiency and bonding performance of the hot melt adhesives.

Near Infrared (NIR) Reactivation Test

Adhesives were cast into films of 2 inch long, 1 inch wide, and 2 mm thick. The film was placed underneath a halogen tungsten lamp (250 W/120 V) of 35 mm long. The lamp was located in an aluminum reflector and the distance between the lamp filament and the adhesive top surface was kept constant (24.5 mm). The input voltage of the lamp was precisely controlled so that the power of the lamp was 140 W. The adhesive film was heated by the lamp for 20 seconds and the surface temperature of the adhesive film was continuously measured using an infrared thermal probe. The surface temperature (temperature after 20 second irradiation, beginning temperature of 70° F.) reported in the tables below are the average of six samples tested for each formulation.

Bond Strength Test

Adhesives in a bead shape were pre-coated on corrugated paperboard at the coating weight of 1.5 g/m. The bead cross-section had a dimension of 2 mm×2 mm. The pre-applied adhesive beads were cooled down to room temperature and then were subjected to NIR radiation for various periods of time. NIR radiant energy was emitted by a 240 W halogen tungsten lamp, which was placed in an aluminum reflector. The distance of the lamp filament and the adhesive bead was precisely controlled as 10.5 mm. After being radiated, the adhesive bead was exposed to air for 3.5 seconds and then another corrugated substrate (2″×2″) was placed on the top of the adhesive bead to form a bond. The bond was pressed at 1 kgf/cm² for a certain period of time and then was pulled apart. The resulting bond force, adhesive bead flatness, and the percentage of fiber tear were recorded. The bead flatness measured the deform-ability and flow-ability (i.e., the level of reactivation) of the hot melt adhesive under the test condition.

### Example 1

This example illustrates the influence of the concentration of the energy-absorbing ingredient on the reactivation efficiency and bonding performance.

A sample (Sample A) of an EVA, paraffin wax, and hydrocarbon tackifier based hot melt adhesive available from National Starch & Chemical Company (Cool-Lok® 34-2125) was compared to adhesive samples (Samples B-F) to which various amounts of carbon black (Regal 400, Cabot) had been added. Samples B-E were prepared by fully blending the adhesive and Regal 400 using a paddle mixer and all Samples had the same level of dispersion quality. The increase in adhesive temperature that occurred during the NIR reactivation test (described above) was determined and is reported in Table 1. In the Bond Strength Test, the adhesive bead was radiated for 0.3 seconds, and the bond was pressed for 15 seconds. Results (bond force, % bead flatness and % fiber tear) are reported in Table 1.

TABLE 1

| Sample | A | B | C | D | E | F |
|---|---|---|---|---|---|---|
| Additive Regal 400 | 0 | 0.1 | 0.3 | 0.5 | 0.75 | 1.5 |
| Concentration | | | | | | |
| (wt %) | | | | | | |
| Radiation Time (S) | 0.3 | 0.3 | 0.3 | 0.3 | 0.3 | 0.3 |
| Compression Time | 15 | 15 | 15 | 15 | 15 | 15 |
| (S) | | | | | | |
| Adhesive Surface | 125 | 200 | 250 | 282 | 293 | 306 |
| Temperature (° F.) | | | | | | |
| Bond Strength | <1 | 2-4 | >6 | >5 | 2-4 | <1 |
| (KgF) | | | | | | |
| Bead Flatness (%) | 0 | 50 | 100 | 100 | 25 | 25 |
| Fiber Tear (%) | 0 | 1-25 | 75-100 | 50-75 | 1-25 | 1-25 |

The results indicate that the adhesive surface temperature increased monotonically with the additive concentration increasing from 0 wt % to 1.5 wt %. However the bonding performance, such as bond strength, bead flatness, and fiber tear, showed a peak value at the additive concentration in the range from 0.3 to 0.5 wt %.

### Example 2

Additional pigments or solid particulates useful in the practice of the invention and the influence of the pigment type and concentration on the reactivation efficiency of Cool-Lok® 34-2125 are illustrated in this example. Monarch 1400 is a carbon black available from Cabot, Monarch 4750 is a carbon black available from Cabot, Printex is a carbon black available from Degussa, the graphite (particle size 1-2 microns) was obtained from Aldrich. Disperbyk is a dispersing agent available from Bykchemie. The samples were prepared by fully blending the adhesive and energy-absorbing ingredient with a mixer. Results are reported in Table 2.

TABLE 2

| Example | G | H | I | J |
|---|---|---|---|---|
| Monarch 1400 | 0.5 | | | |
| (wt %) | | | | |
| Monarch 4750 | | 0.5 | | |
| (wt %) | | | | |
| Printex L6 (wt %) | | | 1 | |
| Graphite (wt %) | | | | 1 |
| Disperbyk 108 | 0.5 | 0.5 | | |
| (wt %) | | | | |
| Mixer | High | High | Paddle | Paddle |
| | Shear | Shear | Mixer | Mixer |
| | Mixer | Mixer | | |
| Radiation time | 0.3 | 0.3 | 0.7 | 0.7 |
| (S) | | | | |
| Compression | 15 | 15 | 15 | 15 |
| Time (wt %) | | | | |
| Surface | 270 | 300 | 286 | 286 |
| Temperature | | | | |
| (° F.) | | | | |
| Bond Strength | >6 | >6 | >6 | >6 |
| (KgF) | | | | |
| Bead Flatness | 100 | 100 | 100 | 100 |
| (%) | | | | |
| Fiber Tear (%) | 100 | 75-100 | 75-100 | 75-100 |

Samples G and H composed of finely dispersed nano-scale particles (agglomerate sizes<10 microns) contained relatively low concentrations of pigment to achieve efficient reactivation and bond strength. Samples I and J required greater concentrations due to their different particle sizes (1-2 micron) and dispersion quality. Results from these examples demonstrated that a variety of materials could be used within the scope of this invention, with performance tailored dependently on the particle size, type, radiation time, dispersion quality, and additive concentrations.

### Example 3

### Example 3

This example illustratesd the utility of various NIR absorbing dyes as the energy-absorbing ingredient in providing short reactivation time and high bond strength. These dyes were dissolved homogeneously into the base hot melt adhesive (Cool-Lok 34-2125) and absorbed impinging radiant energy, most preferably ranging from 400 nm to 5000 nm in wavelength. Epolight 1125 is a green dye available from Epolight, IR-1050 and IR-1048 are dyes available from Aldrich, Inc. The samples were prepared by uniformly blending the adhesive and dye with a paddle mixer. The influence of NIR absorbing dyes on reactivation efficiency is shown in Table 3.

TABLE 3

| Sample | K | L | M |
|---|---|---|---|
| Epolight 1125 | 0.5 | | |
| (wt %) | | | |
| IR-1050 (wt %) | | 0.5 | |
| IR-1048 (wt %) | | | 0.5 |
| Radiation Time | 0.3 | 0.3 | 0.3 |
| (S) | | | |
| Compression | 15 | 15 | 15 |
| Time (S) | | | |
| Surface | 245 | 245 | 241 |
| Temperature | | | |
| (° F.) | | | |
| Bond Strength | >6 | >6 | >6 |
| (KgF) | | | |
| Bead Flatness | 100 | 100 | 100 |
| Fiber Tear | 100 | 75-100 | 75-100 |

### Example 4

The influence of different base adhesive chemistries on the required compression time is illustrated in this example. Sample N (using an EVA, paraffin wax, and hydrocarbon tackifier based hot melt adhesive available from National Starch & Chemical Company (Cool-Lok® 34-2125)) was compared to Sample O (using an EnBA, paraffin wax, hydrocarbon based hot melt adhesive available from National Starch & Chemical Company (34-2100)) and Sample P (using a hot melt adhesive based on EVA, tackifier and wax available from National Starch & Chemical Company (34-100A)). The samples were prepared by fully blending the adhesive and carbon black (Monarch 4750, Cabot) with a high shear mixer. Good dispersion quality was obtained (agglomerate sizes<10 microns). The results are summarized in Table 4.

TABLE 4

| Sample | N | 0 | P |
|---|---|---|---|
| Viscosity at 350° F. | 200 | 810 | 4700 |
| Viscosity at 250° F. | 1125 | 3100 | 19200 |
| Additive Monarch 4750 | 0.5 | 0.5 | 0.5 |
| Concentration (wt %) | | | |
| Disperbyk 108 (wt %) | 0.5 | 0.5 | 0.5 |
| Radiation Time (s) | 0.3 | 0.7 | 0.7 |
| Compression Time (s) | 15 | 8 | 8 |
| Surface Temperature (° F.) | 300 | 330 | 328 |
| Bond Strength (KgF) | >6 | >6 | >6 |
| Bead Flatness (%) | 100 | 100 | 100 |
| Fiber Tear (%) | 75-100 | 75-100 | 75-100 |

This example indicates that using 34-2100 or 34-100A as the base adhesive, 8 seconds of compression was required to give good bonding performance (strong bond force, high percentage of bead flatness, and full fiber tear). However when 34-2125 was employed as the base adhesive, the bonds had to be compressed for 15 seconds to give the same level of bonding performance. A short compression time might be desirable in applications where the length of the compression section was limited.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A reactivatable adhesive composition comprising an effective amount of an energy-absorbing ingredient such that upon exposure of the adhesive to radiant energy, the adhesive is activated.

2. The adhesive of claim 1 which is a hot melt adhesive.

3. The adhesive of claim 1 wherein said radiant energy has a wavelength of from about 400 nm to about 100,000 nm.

4. The adhesive of claim 1 wherein the energy-absorbing ingredient is dissolved in the adhesive composition.

5. The adhesive of claim 1 wherein the energy-absorbing ingredient is dispersed in the adhesive composition.

6. The adhesive of claim 4 wherein the energy-absorbing ingredient comprises an organic dye.

7. The adhesive of claim 5 wherein the energy-absorbing ingredient comprises a pigment.

8. The adhesive of claim 5 wherein the pigment is carbon black.

9. The adhesive of claim 5 wherein the pigment is graphite.

10. An adhesive which has been applied to at least a portion of a first substrate and allowed to solidify, said adhesive being reactivatable upon exposure to radiant energy whereupon the adhesive is capable of bonding the first substrate to a second substrate, said adhesive comprising an effective amount of an energy-absorbing ingredient sensitive to said radiant energy.

11. A process for bonding at least a first substrate to at least a second substrate, wherein at least a portion of at least one of said substrates has applied thereon the adhesive of claim 1, said method comprising irradiating the applied adhesive with radiant energy for a time sufficient to melt the adhesive, bringing one of said substrates in contact with the melted adhesive on the other substrate, and allowing the adhesive to solidify thereby bonding the first substrate to the second substrate.

12. A method of closing a container having applied on at least one surface substrate thereof the reactivatable adhesive of claim 1, said method comprising exposing the reactivatable adhesive of claim 1 to radiant energy for a time sufficient to melt said adhesive, bringing a second surface substrate in contact with the reactivated adhesive on the first surface substrate and, optionally, applying pressure to effect said closing.

13. The method of claim 12 wherein pressure is applied for less than about 30 seconds.

14. The method of claim 12 where the adhesive is exposed to said radiant energy for less that about 5 seconds.

12. An article of manufacture comprising the adhesive of claim 1.

13. The article of claim 12 wherein said article is a container.

14. The article of claim 13 wherein the container is a case, carton, try or bag.

15. The article of claim 12 wherein said article is nonwoven absorbant article.

16. The article of claim 15 wherein the absorbant article is a diaper.
